(19) United States
(12) Patent Application Publication
(10) Pub. No.: US 2026/0265648 A1
(43) Pub. Date: Sep. 10, 2026

(54) NO WATER ADDED LAUNDRY CONCENTRATE DETERGENT SYSTEM AND FORMULA

(71) Applicant: Homecourt Inc., Santa Monica, CA (US)

(72) Inventors: Somil M. Shah, Mount Laurel, NJ (US); Sarah Jahnke, Venice, CA (US); Jessica Aguilar, Westchester, CA (US); Courteney Cox, Malibu, CA (US); Fred Haisam Khoury, Chatsworth, CA (US)

(21) Appl. No.: 19/075,197

(22) Filed: Mar. 10, 2025

(51) Int. Cl. C11D 3/50; C11D 3/20; C11D 3/43

(52) U.S. Cl. CPC C11D 3/50; C11D 3/2034; C11D 3/2068; C11D 3/2096; C11D 3/43; C11D 2111/12

(57) ABSTRACT

A detergent composition comprising: a plurality of raw materials. The plurality of raw materials include surfactants, solvents, preservatives, and stabilizers. The one or more surfactants present in an amount of about 80 percent to about 95 percent of a total weight of the composition. The one or more solvents present in an amount of about 2 percent to about 10 percent of the total weight of the composition. The one or more preservatives present in an amount of about 0.1 percent to about 0.5 percent by the total weight of the composition. The one or more stabilizers present in an amount of about 0.5 percent to about 3 percent by the total weight of the composition. The composition is free of any water other than water present in the plurality of raw materials.

### FIELD

The present teachings relate to a concentrated detergent that does not include any additional water. The concentrated detergent is a liquid that is free of any water added.

Laundry detergents are available that are added to a laundry machine to clean clothes and other items that become dirty. Liquid laundry detergents are available; however, these detergents are primarily water such that an amount of detergent added to the laundry machine is increased to accommodate for the water added to dilute the liquid detergent. Solid detergents are available that are dried to remove water such that the detergents are substantially free of water. Some other detergents are placed in pods or formed into sheets. These detergents may add additional materials or include additional processing steps in order to arrive at a saleable formula.

Thus, there is a need for a concentrated detergent that is free of any added water. There is a need for a detergent where the only water present in the detergent is from the material components as purchased. There is a need for a detergent that is free of any concentrating steps such as heating or dehydrating. It would be desirable to have a concentrated liquid detergent that is dispersible in water. There is a need for a detergent that that increases an number of washed contained in each bottle while minimizing a weight of each bottle so that movement of each bottle does not include movement of water.

### SUMMARY

The present teachings provide: a detergent composition comprising: a plurality of raw materials. The plurality of raw materials include surfactants, solvents, preservatives, and stabilizers. The one or more surfactants present in an amount of about 80 percent to about 95 percent of a total weight of the composition. The one or more solvents present in an amount of about 2 percent to about 10 percent of the total weight of the composition. The one or more preservatives present in an amount of about 0.1 percent to about 0.5 percent by the total weight of the composition. The one or more stabilizers present in an amount of about 0.5 percent to about 3 percent by the total weight of the composition. The composition is free of any water other than water present in the plurality of raw materials.

The present teachings provide: a laundry detergent comprising a composition. The composition includes a plurality of raw materials including surfactants, solvents, and stabilizers. The one or more surfactants are present in an amount of about 80 percent to about 95 percent of a total weight of the composition. The one or more solvents are present in an amount of about 2 percent to about 10 percent of the total weight of the composition. The one or more stabilizers are present in an amount of about 0.5 percent to about 3 percent by the total weight of the composition. The composition is free of any water other than water present in the plurality of raw materials so that a bottle holding the laundry detergent holds 475 ml or less of the laundry detergent and the laundry detergent in the bottle is configured to wash 70 loads of laundry or more.

The present teachings provide: a liquid laundry detergent comprising a plurality of raw materials. The plurality of raw materials include surfactants, solvents, preservatives, stabilizers, fragrance, and pH adjusters. The one or more surfactants are present in an amount of about 85 percent to about 92 percent of a total weight of the composition. The one or more solvents are present in an amount of about 3 percent to about 8 percent of the total weight of the composition. The one or more preservatives are present in an amount of about 0.1 percent to about 0.5 percent by the total weight of the composition. The one or more stabilizers are present in an amount of about 0.5 percent to about 3 percent by the total weight of the composition. The fragrance is present in an amount of about 0.5 percent to about 1.5 percent of the total weight of the composition. The pH adjuster is present in an amount of about 0.1 and 0.5 percent of the total weight of the composition so that the detergent composition has a pH between about 7 and 7.5. The composition is free of any water other than water present in the plurality of raw materials.

The present teachings provide a concentrated detergent that is free of any added water. The present teachings provide a detergent where the only water present in the detergent is from the material components as purchased. The present teachings provide a detergent that is free of any concentrating steps such as heating or dehydrating. The present teachings provide a concentrated liquid detergent that is dispersible in water. The present teachings provide a detergent that that increases an number of washed contained in each bottle while minimizing a weight of each bottle so that movement of each bottle does not include movement of water.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a concentrated laundry detergent (e.g., a composition of raw materials that form a detergent). The laundry detergent includes raw materials that are mixed together without any additional water (e.g., the detergent as discussed herein is a composition including the raw materials discussed herein). Stated another way, the only water added to the detergent (e.g., composition) may be any water that is found in the raw materials. The composition of the detergent may be concentrated by only adding raw materials and not adding any additional components. The detergent may have a concentration such that one addition of detergent cleans a load of laundry. One addition of detergent may have an amount of about 3 mL or more, about 4.5 mL or more, about 6 mL or more, or about 6.5 mL or more. One addition of detergent may have an amount of about 30 mL or less, about 25 mL or less about 20 mL or less, about 15 mL or less, about 10 mL or less, or about 7.5 mL or less. One addition of detergent may mix with water in the laundry machine to clean any materials (e.g., clothes, linens, or other fabrics) located within the laundry machine.

The detergent (e.g., a composition of the detergent) may have a viscosity so that the detergent flows. The viscosity may be sufficiently low so that the detergent flows from a bottle. The viscosity may be proportional to a concentration of the detergent. The viscosity and concentration may not be related. Thus, concentration may be increased without increasing viscosity. Viscosity may be controlled by controlling a number of surfactants, types of surfactants, amounts of surfactants, or combination thereof added into the detergent. The viscosity may be achieved without adding any additional water. Stated another way, the raw materials may be mixed together in an initial mixing the detergent may be free of a step of adding any additional materials. The raw materials may be mixed together without a material or a step of concentrating, removing water, drying, heating, distilling, adding a water scavenger, adding a thickening agent, adding a thinning agent, or a combination thereof. The raw materials may be mixed without adding any additional water. The raw materials may be mixed with only the water found in the raw materials and no additional materials such as water. The raw materials are added without pre-dilution, dilution, or both. The raw materials may be added as the raw materials are purchased (e.g., in an original state) without any changes.

All of the raw materials may be natural ingredients. The natural ingredients may be from plants, minerals, microbes, or a combination thereof. The natural ingredients may be an chemical composition that is not altered. The raw materials may comprise one or more surfactants, one or more solvents, one or more preservatives, one or more chelators, one or more fragrances, one or more stabilizers, a pH adjuster (e.g., a base or an acid), or a combination thereof. The raw materials, the composition, or both may be free of added coloring, colorants, dyes, or a combination thereof. The detergent may be a natural color (e.g., a color of the raw material mixed together). The detergent may be free of added coloring, colorants, dyes, or a combination thereof. The raw materials may be added in an amount indicated in table 1. The raw materials may combine together to form a composition that is a detergent.

TABLE 1

| Component of the composition | Percentage |
|---|---|
| Surfactant | 80-95 |
| Solvent | 2-10 |
| Preservative | 0.1-0.5 |
| Chelator | 0.1-0.5 |
| Fragrance | 0.5-3 |
| Stabilizer | 0.5-3 |
| pH adjuster | 0.1-1 |

The surfactants function to reduce surface tension on dirt, debris, scents, or a combination thereof on items to be cleaned in a wash machine. The surfactants may assist in wetting items within the wash machine. The surfactants may disperse the other components of the composition of the detergent. The surfactants may assist in mixing water based components and oil based components. The surfactants may trap dirt. The surfactants may increase activity of the detergent so that the detergent removes dirt from the items in the wash machine. The surfactants may be anionic. The surfactants may be cationic. The surfactants may be amphoteric. The surfactants may be polar, non-polar, or a combination of both. The surfactants may be or include polysorbates, polyethylene glycol, emulsifying wax, glyceryl oleate, glyceryl stearate, ceteareth, oleth, sorbitans, sodium lauryl sulfate, ammonium sulfate, isethionates, benzalkonium, stearalkonium, trimethyl ammonium, methyl sulfates, coco bentaine, lauryl bentaine, hydroxysultaines, lauryl glucoside, lauramine oxide, alkyl polyglucoside, an emulsifying wax, polyglycose, or a combination thereof. The composition may include one surfactant, two or more surfactants, three of more surfactants, or more. When more than one surfactant is present, equal amounts of each surfactant may be used. For example, if two surfactants are present then the amount may be about 1 to 1. If three surfactants are present, then the amounts may be about 1 to 1 to 1. The amount of each of the surfactants used may not be equal or proportional. For example, the total amount of surfactant may equal 100% and a first surfactant may be present in an amount of 20%, a second surfactant present in an amount of about 30%, and the third surfactant may be the remainer (e.g., about 50%). The surfactants may be present in an amount of about 10 percent or more, 20 percent or more, 30 percent or more, 40 percent or more, or about 50 percent or more. The surfactants may be combined together so a total percentage of the various surfactants equal the total percentage of surfactants taught herein (e.g., the percentage taught in table 1). However, a total amount of surfactant may be present in an amount different than table 1.

The surfactants may be present in a total amount of about 50 percent or more, about 60 percent or more, about 70 percent more, about 75 percent or more, about 80 percent or more, or about 85 percent or more of a total weight of the detergent (the total composition). The surfactants may be present in an amount of about 99 percent or less, about 98 percent or less, 95 percent or less, about 92 percent or less, about 90 percent or less, or about 87 percent or less of a total weight of the detergent. If more than one surfactant is present then the surfactants may be present in equal amounts. If more than one surfactant is present than the surfactants may not be present in equal amounts. A first surfactant may be present in an amount of about 35 percent or more, about 38 percent or more, about 40 percent or more, about 45 percent or more, or about 48 percent or more by a total weight of the detergent. A first surfactant may be present in an amount of about 55 percent or less, about 52 percent or less, or about 50 percent or less by a total weight of the detergent. A second surfactant may be present in an amount of about 35 percent or more, about 38 percent or more, about 40 percent or more, about 42 percent or more, or about 44 percent or more by a total weight of the detergent. A second surfactant may be present in an amount of about 55 percent or less, about 52 percent or less, about 50 percent or less, about 45 percent or less by a total weight of the detergent.

The solvents function to assist in dissolving components within the detergent. The solvents function to dissolve substances within the detergent. The solvents may assist the detergent in foaming, creating suds, or both. The solvents may help water based materials and oil based materials in mixing. The solvents may remove oils, dirt, or both. The solvents may be a polar solvent, a non-polar solvent, or both. The solvents may be or include phthalate, phosphate, sodium lauryl sulfoacetate, propanediol, propylene glycol, or a combination thereof. The solvent may assist in dissolving components and holding the components in solution. Thus, the solvent may also act as an emulsifier. A solvent may be present in an amount of about 1 percent or more, about 3 percent or more, about 4 percent or more, about 4.5 percent or more, or about 5 percent or more by a total weight of the detergent. A solvent may be present in an amount of about 10 percent or less, about 8 percent or less, or about 6 percent or less by a total weight of the detergent.

The preservative functions to prevent growth within the detergent. The preservative may prevent the growth of bacteria, mold, fungi, microorganism, or a combination thereof. The preservative may assist in providing shelf life. The preservatives may assist in a providing a shelf-life of about 1 month or more, 3 months or more, 5 months more, 7 months or more, 10 months or more, or about 12 months or more. The preservatives may provide some stabilization. The preservatives may act as a chelator. Stabilizers may not act as a chelator. The preservatives may bind to material, contaminants, heavy metals, materials in contact with materials to be laundered, or a combination thereof. The preservatives may both preserve the detergent and act to bind the components together, bind to metals that contact the detergent, remove hardness in water, prevent rust, remove ions, or a combination thereof. The preservatives may assist keeping the detergent clean and fresh so that the detergent may clean items that are added into the wash machine. The preservatives be or may include: methylisothiazolinone, methylchloroisothiazolinone, neolone, optiphen, rosemary extract, germaben, ethylenediamine tetraacetic acid, phenonip, benzyl benzoate, phenoxyethanol, citric acid, sodium benzoate, trisodium ethylenediamine, benzyl alcohol, ethylhexylglycerin, tocopherol, or a combination thereof. A preservative, chelator, or both may be present in an amount of about 0.1 percent or more, about 0.2 percent or more, about 0.3 percent or more, about 0.4 percent or more, or about 0.5 percent or more by a total weight of the detergent. A preservative, chelator, or both may be present in an amount of about 1 percent or less, about 0.75 percent or less, or about 0.55 percent or less by a total weight of the detergent.

The fragrances function to add smell to the detergent. The fragrances may add a specific smell to the detergent, the items to be cleaned by the detergent, or both. The fragrances may be an oil based fragrance, a water based fragrance, an essential oil, a perfume, natural components, an extract, a resin, or a combination thereof. The fragrance may be created by concentrating a natural substance. The fragrance may include one or more of cedarwood smoke, white leather, sweet cardamom, cinnamon, smoke, flowers, fragrances from flowers, essential oils, roses, hibiscus, coconut, shea butter, rosewater, geranium oil, Comorian ylang-ylang oil, guiacwood, honey, spices, oranges, lemons, limes, grapefruit, musk, jasmine, vanilla, or a combination thereof. The fragrances may be added in a sufficient amount so that the items washed in the laundry retain the smell of the fragrance for about 1 week or more, 2 weeks or more, three weeks or more, or a month or more. Fragrances may be present in an amount of about 0.2 percent or more, about 0.5 percent or more, about 1 percent or more, about 2 percent or more, or about 2.5 percent or more by a total weight of the detergent. Fragrances may be present in an amount of about 5 percent or less, about 4 percent or less, or about 3 percent or less by a total weight of the detergent.

The stabilizers of the detergent function to maintain a color, maintain a fragrance, prevent oils and waters from coming out of solution, or a combination thereof. The stabilizers may increase a shelf life of a detergent. The stabilizers and preservatives may work together to prevent degradation of the detergents so that the detergents may be shelf stable for a period of time. A stabilizer and/or preservative may provide both stabilization and preservation. The period of time may be about 1 month or more, 3 months or more, about 5 months or more, about 7 months or more, about 9 months or more, about 11 months or more, or about 1 year or more. The stabilizers be or include sodium benzoate, rosemary extract, vitamin E oil, vanillin, benzyl alcohol, ethylhexylglycerin, tocopherol, or a combination thereof. The preservatives may act as both a stabilizer and a preservative. Thus, only a stabilizer or only a preservative may be added but both functions may be enabled. Stabilizers may be present in an amount of about 0.2 percent or more, about 0.5 percent or more, about 1 percent or more, about 2 percent or more, or about 2.5 percent or more by a total weight of the detergent. Stabilizers may be present in an amount of about 5 percent or less, about 4 percent or less, or about 3 percent or less by a total weight of the detergent.

A pH adjuster may adjust a pH of the detergent. The pH may be adjusted to a neutral pH (e.g., substantially at 7). The pH adjuster may be an acid or a base. The pH adjuster may be a natural pH adjuster. The pH adjuster may be an acid, such as a citric acid, malic acid, tartaric acid, lactic acid, acetic acid, ascorbic acid, oxalic acid, hydrochloric acid, sulfuric acid, phosphoric acid, nitric acid, or a combination thereof, the pH adjuster may be a base, such as calcium carbonate, sodium bicarbonate, ammonia, magnesium hydroxide, potassium hydroxide, calcium hydroxide, sodium hydroxide, calcium hydroxide, magnesium hydroxide, sodium carbonate, ammonium hydroxide, or a combination thereof, the pH adjuster may be added in a sufficient amount to adjust the pH of the detergent to be neutral, slightly basic (e.g., between 7 and 8), slightly acidic (e.g., between 6 and 7), or a combination thereof. The pH adjuster may be added as a solid, in a crystalline form, as a substance with no water, as an anhydrous substance, or a combination thereof. A pH adjuster may be added in a sufficient amount so that a desired pH may be achieved. A pH adjuster may be present in an amount of about 0.1 percent or more, about 0.2 percent or more, about 0.3 percent or more, about 0.5 percent or more, or about 0.75 percent or more by a total weight of the detergent. A pH adjuster may be present in an amount of about 2 percent or less, about 1.5 percent or less, or about 1 percent or less by a total weight of the detergent.

The composition set forth herein may be created by combining one or more components (e.g., raw materials) taught herein. The components may be added in virtually any order. However, the components may be added in a specific order. The components may be added together to create a mixture of the components. The mixture may include a surfactant, solvent, preservative, chelator, fragrance, a stabilizer, or a combination thereof. The components may be added in an absence of any additional water. Stated another way, the only water added into the mixture is found in the raw materials. The components may be mixed until the mixture is a homogeneous mixture. The mixture may be mixed with only the constituents of the raw materials and no additional components (e.g., water). The raw materials may be free of being pre-diluted, post-diluted, or both. Once a homogeneous mixture (e.g., a composition) is created then the pH may be adjusted with a pH adjuster until a predetermined pH is achieved. The pH may be adjusted until the mixture (e.g., composition) has a pH of between about 7 and 7.5. The pH may be adjusted without any water being added. The mixture once adjusted may be a detergent. The detergent may be provided into a bottle to store the detergent for use. The bottle may hold about 475 ml of fluid and the bottle may provide about 70 washes of laundry. The detergent (e.g., composition) may be added to a laundry machine in a sufficient amount to clean laundry. The sufficient amount may be about 7.5 ml or less, about 7.0 ml or less, about 6.5 ml or less, or about 6.25 ml or less detergent per load of laundry.

In one example, the raw materials are combined together to form a composition. The raw materials are added without any pre-processing steps. The raw materials are combined in any order to form the composition. A first surfactant is added in an amount of about 48% of a total weight. A second surfactant is added in an amount of about 44% of a total weight. A preservative/stabilizer/chelator is added in an amount of about 5% of a total weight. A fragrance is added in an amount of about 1%. Three preservatives are added that total 1% of a total weight. The raw materials are mixed together without adding any water and only including the raw materials. A homogeneous mixture is formed and then the homogeneous mixture is pH adjusted. The pH is adjusted by adding a pH adjuster so that the pH is between 7 and 7.5. The pH adjusted mixture is then provided into bottles for distribution.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A detergent composition comprising:
a plurality of raw materials comprising:
one or more surfactants present in an amount of about 80 percent to about 95 percent of a total weight of the detergent composition;
one or more solvents present in an amount of about 2 percent to about 10 percent of the total weight of the detergent composition;
one or more preservatives present in an amount of about 0.1 percent to about 0.5 percent by the total weight of the detergent composition; and
one or more stabilizers present in an amount of about 0.5 percent to about 3 percent by the total weight of the detergent composition;
wherein the detergent composition is free of any water other than water present in the plurality of raw materials.

2. The detergent composition of claim 1, further comprising:
a fragrance present in an amount of about 0.5 percent to about 3 percent of the total weight of the detergent composition.

3. The detergent composition of claim 1, further comprising:
a sufficient amount of pH adjuster so that the detergent composition has a pH between about 7 and 7.5.

4. The detergent composition of claim 1, wherein the one or more surfactants are a first surfactant present in an amount of between about 42 percent and about 50 percent of the total weight of the composition and a second surfactant present in an amount of about 38 percent to about 45 percent of the total weight of the composition.

5. The detergent composition of claim 1, wherein the stabilizers comprise benzyl alcohol, ethylhexylglycerin, and tocopherol.

6. The detergent composition of claim 1, wherein the detergent composition has a viscosity between about 250 and 500 cps.

7. The detergent composition of claim 1, wherein the plurality of raw materials are all natural ingredients.

8. The detergent composition of claim 1, wherein the stabilizers both stabilize the detergent composition and preserve the detergent composition.

9. The detergent composition of claim 1, wherein the detergent composition is free of any coloring, colorants, dyes, or a combination thereof.

10. The detergent composition of claim 1, wherein the detergent composition is a laundry detergent that is configured to be applied in a sufficient amount to clean items within a laundry machine.

11. The detergent composition of claim 10, wherein the sufficient amount is about 7.5 ml or less per load of laundry.

12. A laundry detergent comprising:
composition comprising:
a plurality of raw materials comprising:
one or more surfactants present in an amount of about 80 percent to about 95 percent of a total weight of the composition;
one or more solvents present in an amount of about 2 percent to about 10 percent of the total weight of the composition; and
one or more stabilizers present in an amount of about 0.5 percent to about 3 percent by the total weight of the composition;
wherein the composition is free of any water other than water present in the plurality of raw materials so that a bottle holding the laundry detergent holds 475 ml or less of the laundry detergent and the laundry detergent in the bottle is configured to wash 70 loads of laundry or more.

13. The laundry detergent of claim 12, wherein the plurality of raw materials are all natural ingredients.

14. The laundry detergent of claim 12, further comprising:
one or more preservatives present in an amount of about 0.1 percent to about 0.5 percent by the total weight of the composition;
a fragrance present in an amount of about 0.5 percent to about 3 percent of the total weight of the composition; and
a sufficient amount of pH adjuster so that the detergent composition has a pH between about 7 and 7.5;
wherein the detergent composition has a viscosity between about 250 and 500 cps.

15. The laundry detergent of claim 14, wherein the detergent composition is free of any coloring, colorants, dyes, or a combination thereof.

16. The laundry detergent of claim 14, wherein the detergent composition is a laundry detergent that is configured to be applied in a sufficient amount to clean items within a laundry machine, and
the sufficient amount is about 7.5 ml or less per load of laundry.

17. A liquid laundry detergent comprising:
a plurality of raw materials comprising:
one or more surfactants present in an amount of about 85 percent to about 92 percent of a total weight of the liquid laundry detergent;
one or more solvents present in an amount of about 3 percent to about 8 percent of the total weight of the liquid laundry detergent;
one or more preservatives present in an amount of about 0.1 percent to about 0.5 percent by the total weight of the liquid laundry detergent;
one or more stabilizers present in an amount of about 0.5 percent to about 3 percent by the total weight of the liquid laundry detergent;
a fragrance present in an amount of about 0.5 percent to about 1.5 percent of the total weight of the composition; and
a pH adjuster in an amount of about 0.1 and 0.5 percent of the total weight of the composition so that the liquid laundry detergent has a pH between about 7 and 7.5;
wherein the composition is free of any water other than water present in the plurality of raw materials.

18. The liquid laundry detergent of claim 17, wherein the one or more surfactants are a first surfactant present in an amount of between about 44 percent and about 50 percent of the total weight of the liquid laundry detergent and a second surfactant present in an amount of about 41 percent to about 45 percent of the total weight of the liquid laundry detergent.

19. The liquid laundry detergent of claim 17, wherein the liquid laundry detergent has a viscosity between about 250 and 500 cps.

20. The liquid laundry detergent of claim 19, wherein the liquid laundry detergent is configured to be applied in a sufficient amount to clean items within a laundry machine, and
the sufficient amount is about 7.5 ml or less per load of laundry.
